(19) United States
(12) Patent Application Publication
(10) Pub. No.: US 2026/0016782 A1
(43) Pub. Date: Jan. 15, 2026

(54) TRANSPORT DEVICE AND IMAGE FORMING APPARATUS

(71) Applicant: FUJIFILM Business Innovation Corp., Tokyo (JP)

(72) Inventor: Kohei IKENAGA, Kanagawa (JP)

(73) Assignee: FUJIFILM Business Innovation Corp., Tokyo (JP)

(21) Appl. No.: 19/034,576

(22) Filed: Jan. 23, 2025

(30) Foreign Application Priority Data
Jul. 11, 2024 (JP) 2024-112013

(51) Int. Cl. G03G 15/00; B65H 5/06

(52) U.S. Cl. CPC G03G 15/657; B65H 5/062; B65H 2404/144; G03G 2215/00548

(57) ABSTRACT

A transport device includes a positioning roller that positions a leading end of a recording medium; a pressing roller that presses the leading end of the recording medium against the stopped positioning roller to form a loop in the recording medium between the pressing roller and the positioning roller; a drive member that rotationally drives the stopped positioning roller to release the loop and transport the recording medium; a guide member that is disposed between the pressing roller and the positioning roller in a transport direction of the recording medium, is separated from the recording medium in which the loop is formed, and guides the recording medium in which the loop is released to a downstream side in the transport direction; and a flexible member that is flexible in a case of coming into contact with the recording medium in which the loop is released and is pressed against the guide member by the recording medium.

### CROSS-REFERENCE TO RELATED APPLICATIONS

This application is based on and claims priority under 35 USC 119 from Japanese Patent Application No. 2024-112013 filed Jul. 11, 2024.

### BACKGROUND

### (i) Technical Field

The present invention relates to a transport device and an image forming apparatus.

### (ii) Related Art

A paper transport device disclosed in JP2009-40565A includes paper feeding section that feeds paper accommodated in a paper feeding unit one by one, a resist roller pair that temporarily stops the paper to transport the paper at a predetermined timing, a transport section that transports the paper fed from the paper feeding section to the resist roller pair, and a first transport guide plate that guides a back surface of the paper from the transport section to the resist roller pair and a second transport guide plate that guides a front surface of the paper, in which a sound absorbing material layer is provided on an inner surface on a side of at least one of the first and second transport guide plates that guides the paper, and a low friction layer having a smaller friction resistance than the sound absorbing material layer is formed on the sound absorbing material layer at a predetermined interval.

### SUMMARY

In the related art, there is a positioning roller that positions the leading end of a recording medium to be transported. The leading end of the recording medium is pressed against the stopped positioning roller by a pressing roller disposed on an upstream side of the positioning roller in a transport direction of the recording medium. Accordingly, a loop is formed between the positioning roller and the pressing roller, and the leading ends of the recording medium is positioned. Then, after the loop is formed, the recording medium is transported to the downstream in the transport direction by rotating the positioning roller.

Here, the loop is released by rotating and moving the positioning roller. When the loop is released, the recording medium directly knocks the guide member that guides the recording medium, and a knocking sound is generated.

Aspects of non-limiting embodiments of the present disclosure relate to a transport device and an image forming apparatus that suppresses the generation of a knocking sound when a loop is released, as compared with a case where a recording medium directly knocks a guide member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a transport device including: a positioning roller that positions a leading end of a recording medium; a pressing roller that presses the leading end of the recording medium against the stopped positioning roller to form a loop in the recording medium between the pressing roller and the positioning roller; a drive member that rotationally drives the stopped positioning roller to release the loop and transport the recording medium; a guide member that is disposed between the pressing roller and the positioning roller in a transport direction of the recording medium, is separated from the recording medium in which the loop is formed, and guides the recording medium in which the loop is released to a downstream side in the transport direction; and a flexible member that is flexible in a case of coming into contact with the recording medium in which the loop is released and is pressed against the guide member by the recording medium.

### BRIEF DESCRIPTION OF THE DRAWINGS

Exemplary embodiment(s) of the present invention will be described in detail based on the following figures, wherein:

FIG. 1 is a schematic configuration diagram showing an image forming apparatus according to an exemplary embodiment of the present disclosure;

FIG. 2 is a schematic configuration diagram showing an image forming unit provided in the image forming apparatus according to the exemplary embodiment of the present disclosure;

FIG. 3 is a configuration diagram showing a transport device according to the exemplary embodiment of the present disclosure;

FIG. 4 is a block diagram showing a control system of a control unit provided in the transport device according to the exemplary embodiment of the present disclosure;

FIG. 5 is a perspective view showing a part of the transport device according to the exemplary embodiment of the present disclosure;

FIG. 6A is a front view and FIG. 6B is a side view showing a flexible member provided in the transport device according to the exemplary embodiment of the present disclosure;

FIGS. 7A and 7B are process views showing a transport process of a recording medium transported by the transport device according to the exemplary embodiment of the present disclosure;

FIGS. 8A and 8B are process views showing a transport process of a recording medium transported by the transport device according to the exemplary embodiment of the present disclosure;

FIGS. 9A and 9B are process views showing a transport process of a recording medium transported by the transport device according to the exemplary embodiment of the present disclosure; and

FIGS. 10A and 10B are process views showing a transport process of a recording medium transported by the transport device according to the exemplary embodiment of the present disclosure.

### DETAILED DESCRIPTION

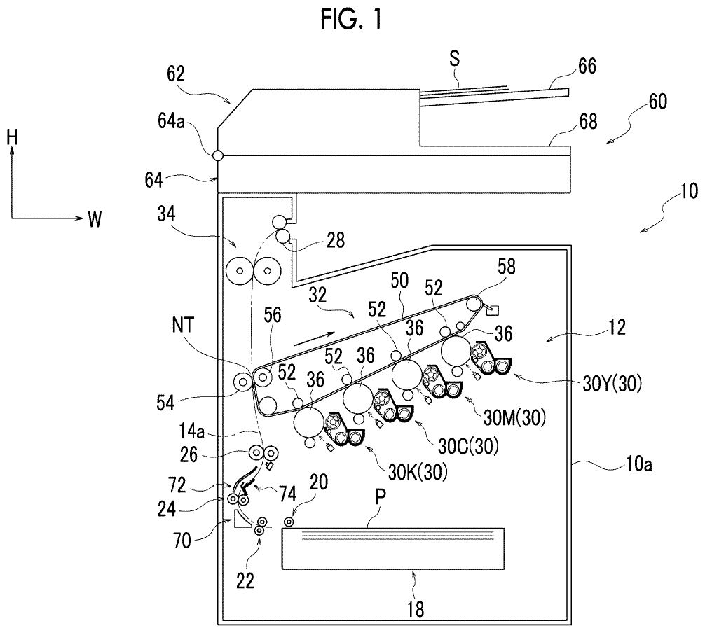

An example of a transport device and an image forming apparatus according to an exemplary embodiment of the present disclosure will be described with reference to FIGS. 1 to 10. The arrow H shown in each drawing indicates a vertical direction, which is an up-down direction of the apparatus. The arrow W is orthogonal to the arrow H and indicates the width direction of the apparatus in a horizontal direction. The arrow D is orthogonal to the arrows H and W and indicates the depth direction of the apparatus in the horizontal direction.

### Overall Configuration of Image Forming Apparatus 10

As illustrated in FIG. 1, an image forming apparatus 10 includes an image reading unit 60 and an image forming unit 12 that forms a toner image. Further, the image forming apparatus 10 includes a transport device 14 that transports a sheet member P as a recording medium along a transport path 14a and an accommodating member 18 that accommodates the sheet member P.

In the configuration, in the image forming apparatus 10, the sheet member P accommodated in the accommodating member 18 is transported by the transport device 14 along the transport path 14a. Further, the toner image is formed by the image forming unit 12 based on the image data read by the image reading unit 60. Further, the toner image is formed on the transported sheet member P, and the sheet member P to which the toner image is formed is discharged to the outside of an apparatus body 10a.

### Image Forming Unit 12

As shown in FIG. 1, the image forming unit 12 includes a plurality of toner image forming units 30 that form toner images of respective colors and a transfer unit 32 that transfers the toner images formed by the toner image forming units 30 to the sheet member P. Further, the image forming unit 12 includes a fixing device 34 that fixes the toner images, which are transferred to the sheet member P by the transfer unit 32, to the sheet member P.

### Toner Image Forming Unit 30

The plurality of toner image forming units 30 are provided to form toner images for respective colors. In the present exemplary embodiment, in total, four colors of yellow (Y), magenta (M), cyan (C), and black (K) toner image forming units 30Y, 30M, 30C, and 30K are provided. In the following description, in a case where there is no need to distinguish between yellow (Y), magenta (M), cyan (C), and black (K), Y, M, C, and K attached as the reference numerals are omitted.

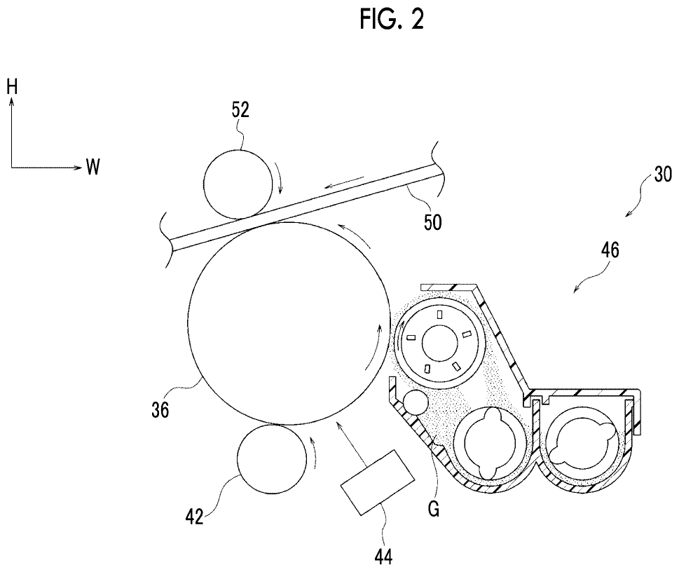

The toner image forming unit 30 of each color is basically configured the same except for a toner to be used. As shown in FIG. 2, the toner image forming unit 30 includes a rotating columnar image holder 36 and a charger 42 that charges the image holder 36. Further, the toner image forming unit 30 includes an exposure device 44 that irradiates the charged image holder 36 with exposure light to form an electrostatic latent image and a developing device 46 that develops the electrostatic latent image by using a developer G containing a toner as a toner image. As a result, the toner image forming unit 30 of each color forms an image of each color using a toner of each color.

In addition, as shown in FIG. 1, the image holder 36 of each color is in contact with a transfer belt 50 (details to be described below) that moves circumferentially. In a circumferential direction (see an arrow in the drawing) of the transfer belt 50, the yellow (Y), magenta (M), cyan (C), and black (K) toner image forming units 30 are arranged in turn from an upstream side.

### Transfer Unit 32

As shown in FIG. 1, the transfer unit 32 includes an endless transfer belt 50. Further, the transfer unit 32 includes a primary transfer roller 52 that is disposed on each of the opposite sides of the image holder 36 of each color with the transfer belt 50 interposed therebetween and that transfers the toner image formed on the image holder 36 of each color to the transfer belt 50.

In addition, the transfer unit 32 includes a winding roller 56 around which the transfer belt 50 is wound, and a drive roller 58 around which the transfer belt 50 is wound and which transmits a rotational force to the transfer belt 50. As a result, the transfer belt 50 is circumferentially driven in an arrow direction in the drawing.

Further, the transfer unit 32 is disposed on an opposite side of the winding roller 56 with the transfer belt 50 interposed therebetween, and includes a secondary transfer roller 54 that transfers the toner image transferred to the transfer belt 50 to the sheet member P. A transfer nip NT where the toner image is transferred to the sheet member P is formed between the secondary transfer roller 54 and the transfer belt 50.

### Fixing Device 34

As shown in FIG. 1, the fixing device 34 is disposed on a downstream side of the transfer nip NT in a transport direction of the sheet member P. The fixing device 34 heats and pressurizes a toner image transferred to the sheet member P to fix the toner image to the sheet member P.

In this configuration, the toner image forming unit 30 for yellow (Y), magenta (M), cyan (C), and black (K) forms a toner image of each color on each image holder 36. The toner image formed on the image holder 36 is sequentially primarily transferred to the transfer belt 50 by the primary transfer roller 52. In addition, the toner image is transferred from the transfer belt 50 to the sheet member P interposed and transported between the transfer belt 50 and the secondary transfer roller 54 by the secondary transfer roller 54.

Further, the sheet member P to which the toner image is transferred is transported toward the fixing device 34. The fixing device 34 fixes the toner image transferred to the sheet member P to the sheet member P.

### Transport Device 14

As shown in FIG. 1, the transport device 14 includes a plurality of transporting rollers. The transport device 14 is configured to feed the sheet member P accommodated in the accommodating member 18 to the transport path 14a to be discharged to the outside of the apparatus body 10a after passing through the transfer nip NT. The details of the transport device 14 will be described later.

### Image Reading Unit 60

As shown in FIG. 1, the image reading unit 60 is disposed above the discharge roller 28 that discharges the sheet member P. The image reading unit 60 includes a document transport unit 62 and a document reading unit 64. In addition, the document transport unit 62 and the document reading unit 64 are connected to each other by a hinge portion 64a provided in the document reading unit 64. Further, the image reading unit 60 includes a paper feed tray 66 that feeds a document S to the document transport unit 62. In addition, the image reading unit 60 includes a discharge tray 68 that discharges the document S transported by the document transport unit 62 and read by the document reading unit 64. The paper feed tray 66 and the discharge tray 68 are attached to the document transport unit 62.

In this configuration, the document transport unit 62 is rotated around the hinge portion 64a, so that the upper surface (platen glass) of the document reading unit 64 is opened upward. The document reading unit 64 reads the image of the document S transported by the document transport unit 62 and the image of the document S placed on the platen glass (not shown) disposed on the upper surface of the document reading unit 64.

### Major Configuration

Next, the transport device 14 will be described in detail.

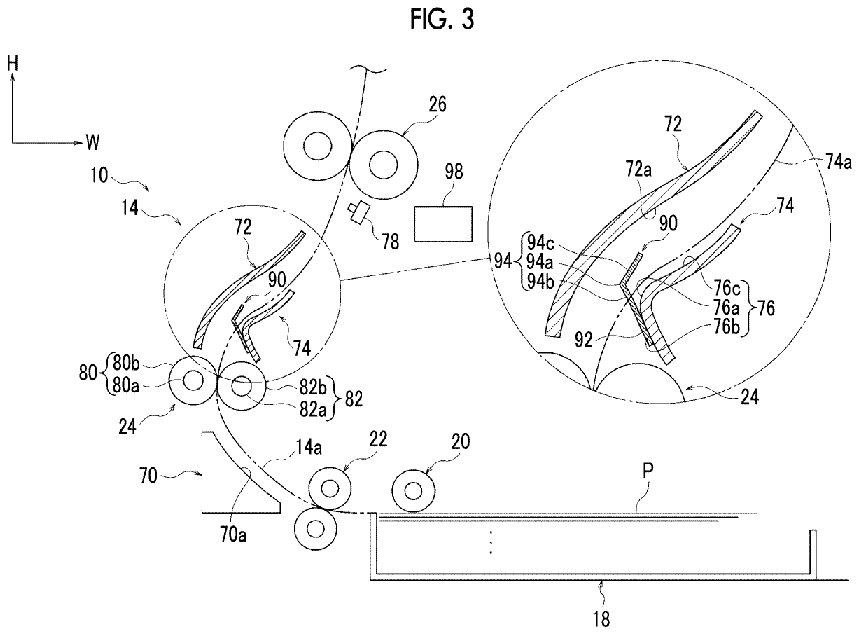

As shown in FIG. 1, the transport device 14 includes a discharge roller 28 that discharges the sheet member P on which the toner image is formed to the outside of the apparatus body 10a. Further, as shown in FIGS. 1 and 3, the transport device 14 includes a feeding roller 20, a double-feeding prevention roller 22, a pressing roller 24, and a positioning roller 26. The feeding roller 20, the double-feeding prevention roller 22, the pressing roller 24, and the positioning roller 26 are arranged in this order from the upstream side to the downstream side in the transport direction (hereinafter, “sheet transport direction”) of the sheet member P.

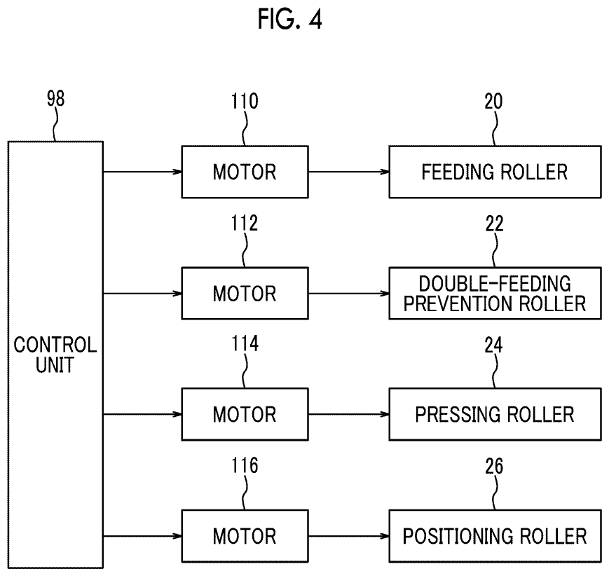

Further, as shown in FIG. 3, the transport device 14 includes paper guides 70, 72, and 74, a detection member 78, and a flexible member 90. In addition, as shown in FIG. 4, the transport device 14 includes a motor 110 that rotates the feeding roller 20 and a motor 112 that rotates the double-feeding prevention roller 22. Further, the transport device 14 includes a motor 114 that rotates the pressing roller 24 and a motor 116 that rotates the positioning roller 26. In addition, the transport device 14 includes a control unit 98 that controls the operation and non-operation of each of the motors 110, 112, 114, and 116. The motor 116 is an example of a drive member.

### Feeding Roller 20 and Double-Feeding Prevention Roller 22

The feeding roller 20 is disposed to be in contact with the uppermost sheet member P among the sheet members P loaded on the accommodating member 18, as shown in FIG. 3, with the axial direction as the depth direction. The feeding roller 20 feeds the uppermost sheet member P loaded on the accommodating member 18 to the transport path 14a.

The double-feeding prevention roller 22 is disposed, with the axial direction as the depth direction, on the downstream side in the sheet transport direction with respect to of the feeding roller 20 and on one side (left side in the drawing) in the width direction with respect to the feeding roller 20. The double-feeding prevention roller 22 prevents the double feeding of the sheet member P fed by the feeding roller 20 and transports the sheet member P to the downstream side in the sheet transport direction.

### Pressing Roller 24 and Paper Guide 70

As shown in FIG. 3, the pressing roller 24 is disposed, with the axial direction as the depth direction, on the downstream side in the sheet transport direction with respect to the double-feeding prevention roller 22 and obliquely upper side (upper side in the drawing) with respect to the double-feeding prevention roller 22. Therefore, the transport path 14a of the portion between the double-feeding prevention roller 22 and the pressing roller 24 is curved.

In addition, the pressing roller 24 is configured with rollers 80 and 82. The roller 80 is disposed on the outside of the curved transport path 14a, and the roller 82 is disposed on the inside of the curved transport path 14a.

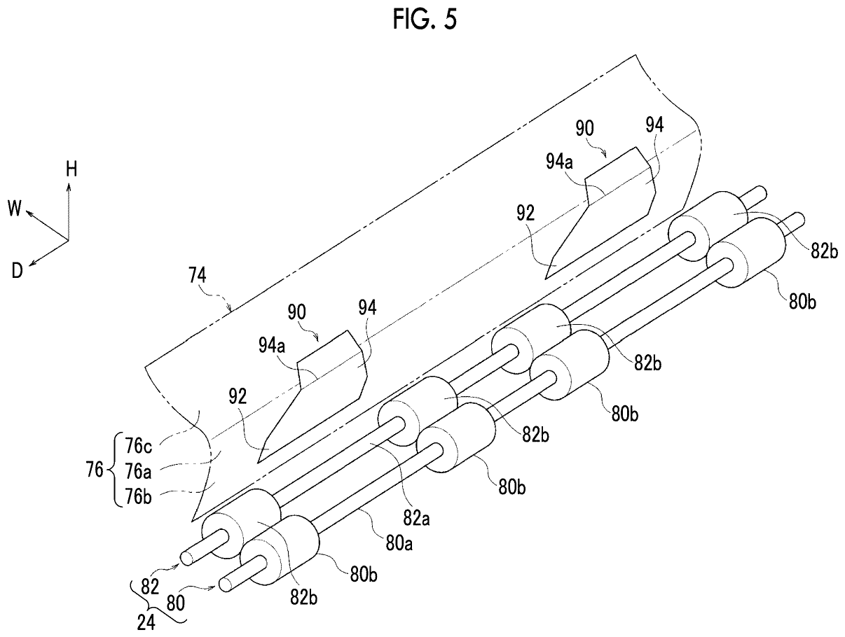

As shown in FIG. 5, the roller 80 includes a shaft 80a and a plurality of cylindrical roller portions 80b into which the shaft 80a is inserted and which are separated from each other in the depth direction. Similarly, the roller 82 has a shaft 82a and a plurality of cylindrical roller portions 82b into which the shaft 82a is inserted and that are separated from each other in the depth direction.

In addition, the paper guide 70 extends in the depth direction and has a guide surface 70a for forming the curved transport path 14a of the portion between the double-feeding prevention roller 22 and the pressing roller 24 as shown in FIG. 3. Accordingly, the sheet member P transported by the double-feeding prevention roller 22 is guided toward the pressing roller 24 by the guide surface 70a of the paper guide 70.

Positioning roller 26, Paper Guide 72, and Paper Guide 74

As shown in FIG. 3, the positioning roller 26 is disposed, with the axial direction as the depth direction, on the downstream side in the sheet transport direction with respect to the double-feeding prevention roller 22 and obliquely upper side (upper side in the drawing) with respect to the double-feeding prevention roller 22. Therefore, the transport path 14a of a portion between the pressing roller 24 and the positioning roller 26 is curved.

The paper guides 72 and 74 extend in the depth direction and are disposed between the pressing roller 24 and the positioning roller 26 in the sheet transport direction as shown in FIG. 3. Specifically, the paper guide 72 is disposed on the outside of the curved portion of the transport path 14a, and the paper guide 74 is disposed on the inside of the curved portion of the transport path 14a. The paper guide 74 is an example of a guide member.

The paper guide 72 has a curved plate shape and has a guide surface 72a facing the transport path 14a.

The paper guide 74 has a curved plate shape and has a guide surface 76 facing the transport path 14a. The guide surface 76 of the paper guide 74 is separated from the guide surface 72a of the paper guide 72, and a loop is formed in the sheet member P to be transported between the guide surface 76 and the guide surface 72a. The loop is a curved bulge formed in the sheet member P by a compressive force.

On the guide surface 76, a protrusion portion 76a protruding toward the transport path 14a and a plane portion 76b on the upstream side in the sheet transport direction with respect to the protrusion portion 76a are formed as viewed from the depth direction. Further, the guide surface 76 is formed with a curved portion 76c on the downstream side in the sheet transport direction with respect to the protrusion portion 76a.

As viewed from the depth direction, the plane portion 76b is inclined such that an upstream portion in the sheet transport direction is separated from the transport path 14a with respect to the downstream portion in the sheet transport direction. In addition, the curved portion 76c is curved so as to be recessed toward the side of the transport path 14a as viewed from the depth direction.

### Detection Member 78 and Flexible Member 90

As shown in FIG. 3, the detection member 78 is disposed on the upstream side of the positioning roller 26 in the sheet transport direction. Accordingly, the detection member 78 detects the leading end of the sheet member P transported along the transport path 14a.

The flexible member 90 is formed by using a resin film. In the present exemplary embodiment, as an example, a Mylar (registered trademark) having a thickness of 0.18 [mm] is used as the resin film.

In addition, as shown in FIG. 5, two flexible members 90 are provided to be separated from each other in the depth direction. The two flexible members 90 are symmetrically with respect to the center of the sheet member P transported in the depth direction and are disposed not to overlap the roller portions 82b of the roller 82 in the depth direction.

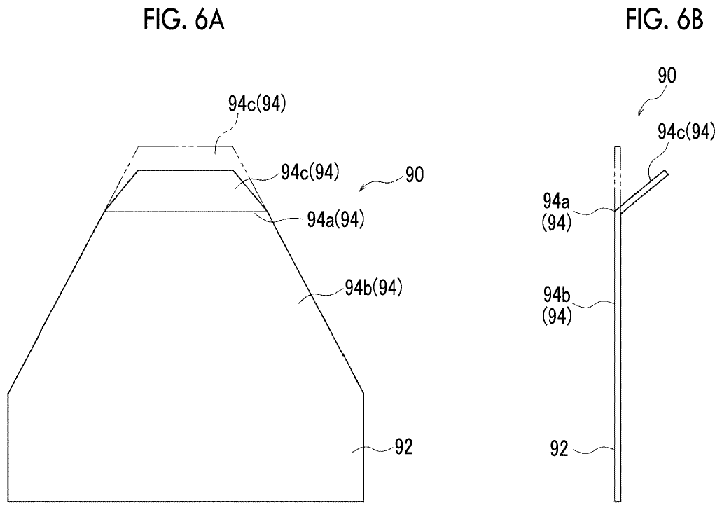

In addition, as shown in FIG. 5 and FIGS. 6A and 6B, the flexible member 90 has an attachment portion 92 attached to the plane portion 76b of the paper guide 74 and a cantilever portion 94 extending from an attachment portion 92 to the side of the transport path 14a. Specifically, the flexible member 90 has a cantilever shape in which a base end is attached to the paper guide 74 and a leading end is a free end with respect to the base end on the downstream side in the sheet transport direction.

Further, a bent portion 94a that is bent such that the side of the sheet member P to be transported is convex is formed at the leading end portion of the cantilever portion 94. In addition, in the cantilever portion 94, a base end portion 94b on the side of the attachment portion 92 and a leading end portion 94c on the side opposite to the base end portion 94b are formed while interposing the bent portion 94a therebetween.

As shown in FIG. 6A, the development shape of the cantilever portion 94 is a trapezoidal shape as viewed in the plate thickness direction of the flexible member 90. Accordingly, each of the base end portion 94b and the leading end portion 94c are has a trapezoidal shape. As shown in FIG. 3, the flexible member 90 protrudes to the side of the paper guide 72 compared to the protrusion portion 76a of the paper guide 74. In the present exemplary embodiment, the cantilever portion 94 is an isosceles trapezoid.

### Control Unit 98

The control unit 98 shown in FIG. 4 controls the operation and non-operation of each of the motors 110, 112, 114, and 116 to control the rotation of each of the rollers. The control of the control unit 98 on the motors 110, 112, 114, and 116 will be described together with the action to be described later.

### Action

Next, the action of the transport device 14 will be described. Specifically, a process of transporting the sheet member P loaded on the accommodating member 18 to the transfer nip NT in order to form an image on the sheet member P will be described. In an initial state where the sheet member P is not being transported, the rotation of all the rollers is stopped.

In a case where the control unit 98 shown in FIG. 3 receives an instruction to transport the sheet member P loaded on the accommodating member 18 from a User Interface (UI) (not shown), the control unit 98 operates the motors 110, 112, and 114 (refer to FIG. 4).

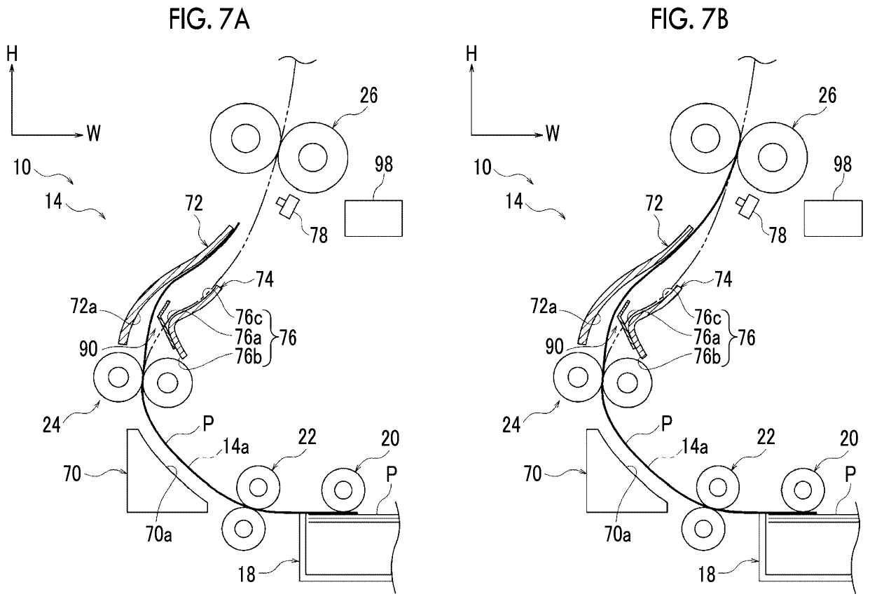

Accordingly, the feeding roller 20, the double-feeding prevention roller 22, and the pressing roller 24 rotate. As shown in FIGS. 7A and 7B, the feeding roller 20 feeds the uppermost sheet member P loaded on the accommodating member 18 to the transport path 14a. In addition, the double-feeding prevention roller 22 prevents the double feeding of the sheet member P fed by the feeding roller 20 and transports the sheet member P toward the paper guide 70 on the downstream side in the sheet transport direction.

Further, the pressing roller 24 receives the sheet member P guided by the guide surface 70a of the paper guide 70, and transports the sheet member P toward the positioning roller 26 through between the paper guide 72 and the paper guide 74. Then, the leading end of the sheet member P transported by each roller is pressed by the nip portion of the stopped positioning roller 26.

Here, in a case where the leading end of the sheet member P reaches the portion of the transport path 14a facing the detection member 78, the detection member 78 detects the leading end of the sheet member P. The control unit 98 receives a detection signal of the detection member 78, continues the operation of each of the motors 110, 112, and 114 for a predetermined time from the reception of the signal, and continues the transport of the sheet member P by the feeding roller 20, the double-feeding prevention roller 22, and the pressing roller 24. That is, the control unit 98 continues to transport the sheet member P by the feeding roller 20, the double-feeding prevention roller 22, and the pressing roller 24 in a state where the leading end of the sheet member P is stopped.

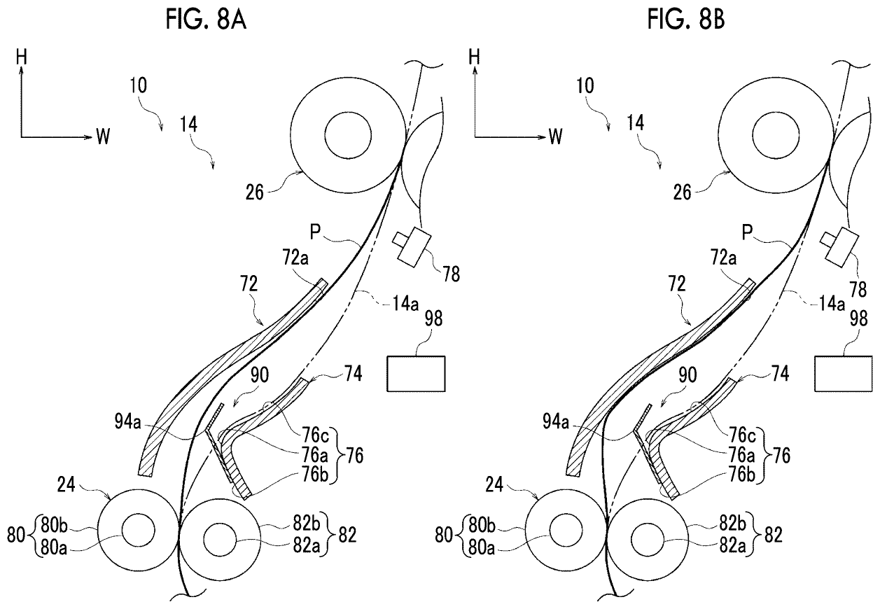

Therefore, as shown in FIGS. 8A and 8B, a loop (bulge) is formed in the sheet member P of a portion between the guide surface 72a of the paper guide 72 and the guide surface 76 of the paper guide 74 due to the compressive force in the sheet transport direction. Accordingly, the leading end of the sheet member P is strongly pressed by the nip portion of the positioning roller 26, and the leading end of the sheet members P is positioned. In a state where the loop is formed in the sheet member P, the sheet member P and the flexible member 90 are separated from each other as shown in FIG. 8B.

In a case where a predetermined time is reached, the control unit 98 non-operates the motors 110, 112, and 114 to stop the transport of the sheet member P by the feeding roller 20, the double-feeding prevention roller 22, and the pressing roller 24. Further, in a case where a predetermined time is reached, the control unit 98 operates the motor 116 to rotationally drive the positioning roller 26. The control unit 98 transports the sheet member P by the positioning roller 26.

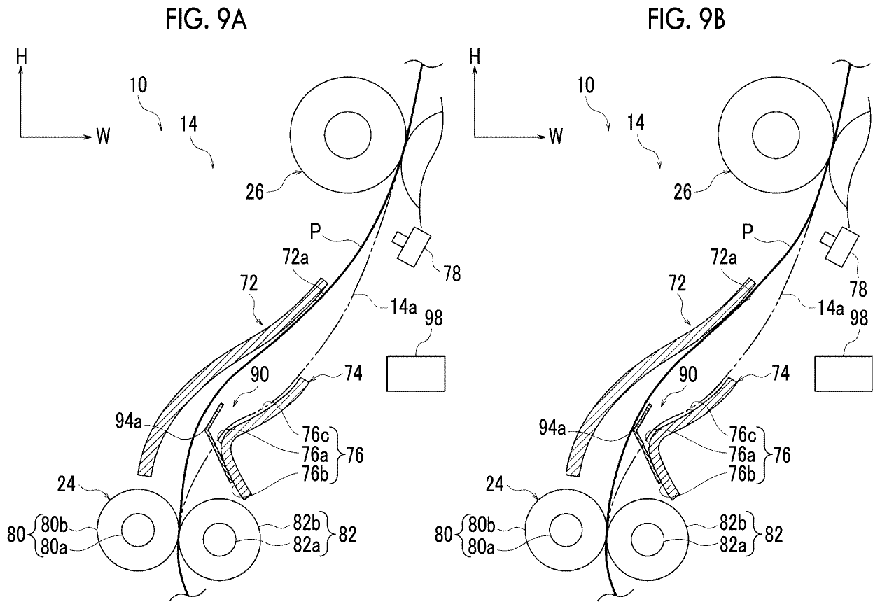

As shown in FIGS. 9A and 9B, the loop (bulge) formed between the guide surface 72a of the paper guide 72 and the guide surface 76 of the paper guide 74 gradually becomes smaller. In other words, the loop is gradually released. The loop of the sheet member P is released, and thus the sheet surface of the sheet member P comes into contact with the protrusion portion 90a of the flexible member 90 (see FIG. 9B).

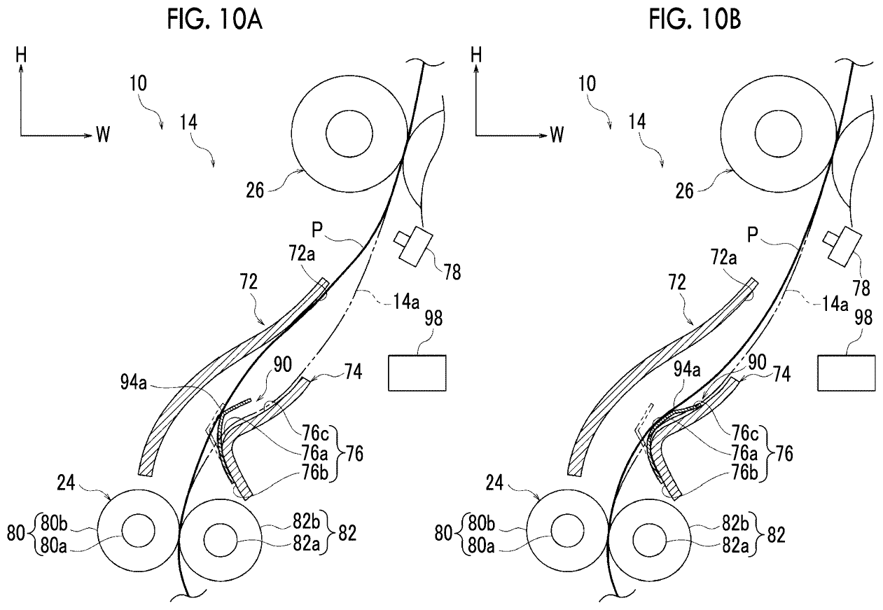

In addition, as the loop is further released, the flexible member 90 is pressed against the sheet member P and is bent as shown in FIGS. 10A and 10B. Then, the bent flexible member 90 is pressed against the guide surface 76 of the paper guide 74 by the sheet member P. The positioning roller 26 transports the sheet member P to the downstream side in the transport direction. The feeding roller 20, the double-feeding prevention roller 22, and the pressing roller 24 are rotated in conjunction with the sheet member P that is transported.

### SUMMARY

As described above, in the transport device 14, the flexible member 90 comes into contact with the sheet member P and bends before the sheet member P, in which the loop is released, knocks the guide surface 76 of the paper guide 74. Accordingly, when the loop is released, the generation of a knocking sound is suppressed as compared with a case where the sheet member P directly knocks the paper guide 74. Here, the direct contact is that the sheet member P comes into contact with the paper guide 74 without interposing anything between the paper guide 74 and the sheet member P.

In addition, in the transport device 14, a plurality of flexible members 90 are provided to be separated from each other in the depth direction (the axial direction of the pressing roller 24), and are disposed on the front side and the back side in the depth direction with respect to at least the center of the transported sheet member P in the depth direction. Accordingly, the generation of the knocking sound is effectively suppressed as compared with a case where only one flexible member is disposed at the center of the sheet member P.

In addition, in the transport device 14, the flexible member 90 is disposed symmetrically with respect to the center of the sheet member P to be transported in the depth direction. Accordingly, a change in the transport posture of the sheet member P when the flexible member 90 is flexible is suppressed as compared with a case where the flexible member is asymmetrically disposed with respect to the center of the sheet member P.

In addition, in the transport device 14, the flexible member 90 is formed of a resin film and has a cantilever shape in which a base end is attached to the paper guide 74 and a leading end is a free end with respect to the base end on the downstream side in the sheet transport direction. Accordingly, an increase in the transport resistance of the sheet member P is suppressed as compared with a case where the leading end is disposed on the upstream side in the sheet transport direction with respect to the base end.

In addition, in the transport device 14, the cantilever portion 94 of the flexible member 90 has a trapezoidal shape in which the base end side is a bottom. Accordingly, the cantilever portion is bent evenly as compared with a case where the cantilever portion has a rectangular shape.

In addition, in the transport device 14, the bent portion 94a that comes into contact with the sheet member P when the loop is released is formed in the flexible member 90. Accordingly, when the loop is released, damage to the sheet member P is suppressed as compared with a case where the edge of the flexible member comes into contact with the sheet member P.

In addition, the image forming apparatus 10 includes the transport device 14. Therefore, when the loop is released, a transport noise is reduced as compared with a case where the transport device is provided in which the sheet member P directly knocks the paper guide.

Although the specific exemplary embodiments of the present disclosure are described in detail, the exemplary embodiment of the present disclosure is not limited to such exemplary embodiments, and it is apparent to those skilled in the art that various other exemplary embodiments can be taken within the scope of the present disclosure. For example, in the above-described exemplary embodiment, the flexible member 90 is disposed on a front side and a back side in the depth direction with respect to at least the center of the transported sheet member P. However, for example, one flexible member may be disposed at the center of the sheet member P. However, in this case, the action obtained by being disposed on the front side and the back side in the depth direction with respect to the center of the sheet member P is not obtained.

In addition, in the above-described exemplary embodiment, the flexible member 90 has a cantilever shape (cantilever support), but may be supported at both ends. However, in this case, the action obtained by having a cantilever shape is not obtained.

In addition, in the above-described exemplary embodiment, the transport device 14 includes the control unit 98, but the control unit of the image forming apparatus 10 may also serve as the control unit of the transport device 14.

In addition, in the above-described exemplary embodiment, the cantilever portion 94 of the flexible member 90 has a trapezoidal shape. However, for example, the cantilever portion may have another shape such as a rectangular shape. However, in this case, the action achieved by the cantilever portion 94 being trapezoidal is not achieved.

(((1)))

A transport device comprising:
a positioning roller that positions a leading end of a recording medium;
a pressing roller that presses the leading end of the recording medium against the stopped positioning roller to form a loop in the recording medium between the pressing roller and the positioning roller;
a drive member that rotationally drives the stopped positioning roller to release the loop and transport the recording medium;
a guide member that is disposed between the pressing roller and the positioning roller in a transport direction of the recording medium, is separated from the recording medium in which the loop is formed, and guides the recording medium in which the loop is released to a downstream side in the transport direction; and
a flexible member that is flexible in a case of coming into contact with the recording medium in which the loop is released and is pressed against the guide member by the recording medium.

(((2)))

The transport device according to (((1))),
wherein a plurality of the flexible members are provided to be separated from each other in an axial direction of the pressing roller, and are disposed on one side and the other side with respect to at least a center of a recording medium to be transported in the axial direction.

(((3)))

The transport device according to (((2))),
wherein a pair of the flexible members are provided, and are disposed symmetrically with respect to the center of the recording medium transported in the axial direction.

(((4)))

The transport device according to any one of (((1)) to (((3)))
wherein the flexible member is formed of a resin film and has a cantilever shape in which a base end is attached to the guide member and a leading end is a free end with respect to the base end on the downstream side in the transport direction of the recording medium.

(((5)))

The transport device according to (((4))),
wherein a cantilever portion of the flexible member has a trapezoidal shape with a base end side as a bottom.

(((6)))

The transport device according to (((4))) or (((5)
wherein the flexible member is formed with a bent portion that protrudes to a side of the recording medium in which the loop is formed, as viewed in an axial direction of the pressing roller.

(((7)))

An image forming apparatus comprising:
the transport device according to any one of claims (((1))) to (((6))); and
an image forming unit that forms an image on the recording medium transported by the transport device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transport device comprising:
a positioning roller that positions a leading end of a recording medium;
a pressing roller that presses the leading end of the recording medium against the stopped positioning roller to form a loop in the recording medium between the pressing roller and the positioning roller;
a drive member that rotationally drives the stopped positioning roller to release the loop and transport the recording medium;
a guide member that is disposed between the pressing roller and the positioning roller in a transport direction of the recording medium, is separated from the recording medium in which the loop is formed, and guides the recording medium in which the loop is released to a downstream side in the transport direction; and
a flexible member that is flexible in a case of coming into contact with the recording medium in which the loop is released and is pressed against the guide member by the recording medium.

2. The transport device according to claim 1,
wherein a plurality of the flexible members are provided to be separated from each other in an axial direction of the pressing roller, and are disposed on one side and the other side with respect to at least a center of a recording medium to be transported in the axial direction.

3. The transport device according to claim 2,
wherein a pair of the flexible members are provided, and are disposed symmetrically with respect to the center of the recording medium transported in the axial direction.

4. The transport device according to claim 1,
wherein the flexible member is formed of a resin film and has a cantilever shape in which a base end is attached to the guide member and a leading end is a free end with respect to the base end on the downstream side in the transport direction of the recording medium.

5. The transport device according to claim 4,
wherein a cantilever portion of the flexible member has a trapezoidal shape with a base end side as a bottom.

6. The transport device according to claim 4,
wherein the flexible member is formed with a bent portion that protrudes to a side of the recording medium in which the loop is formed, as viewed in an axial direction of the pressing roller.

7. An image forming apparatus comprising:
the transport device according to claim 1; and
an image forming unit that forms an image on the recording medium transported by the transport device.

8. An image forming apparatus comprising:
the transport device according to claim 2; and
an image forming unit that forms an image on the recording medium transported by the transport device.

9. An image forming apparatus comprising:
the transport device according to claim 3; and
an image forming unit that forms an image on the recording medium transported by the transport device.

10. An image forming apparatus comprising:
the transport device according to claim 4; and
an image forming unit that forms an image on the recording medium transported by the transport device.

11. An image forming apparatus comprising:
the transport device according to claim 5; and
an image forming unit that forms an image on the recording medium transported by the transport device.

12. An image forming apparatus comprising:
the transport device according to claim 6; and
an image forming unit that forms an image on the recording medium transported by the transport device.
